(19) United States
(12) Patent Application Publication
(10) Pub. No.: US 2014/0101147 A1
(43) Pub. Date: Apr. 10, 2014

(54) SEARCH

(71) Applicant: Neutrino Concepts Limited, Longbridge (GB)

(72) Inventor: PATRICK FOODY, Tingley (GB)

(73) Assignee: Neutrino Concepts Limited, Longbridge (GB)

(21) Appl. No.: 14/043,283

(22) Filed: Oct. 1, 2013

Related U.S. Application Data
(60) Provisional application No. 61/708,542, filed on Oct. 1, 2012.

(51) Int. Cl. G06F 17/30

(52) U.S. Cl. CPC G06F 17/3053; G06F 17/30554
USPC 707/729; 707/730

(57) ABSTRACT

A computer system for assisting searching of a database of a plurality of attributes, measures and content in order to answer analytical queries, the system comprising an input device for receiving word queries requesting information and/or metrics from the database a processor configured to process word queries requesting information and/or metrics from the database; and a storage memory containing a plurality of responses to word queries which responses contain and/or correspond to attributes, content and/or measures of the database, and containing one or more ordered combinations of attributes wherein the attributes of the ordered combinations are in a set order, the processor configured to match one or more words in a received word query with one or more attribute, content and/or measure in or corresponding to the stored responses, to provide relevant responses to the input word query based on the matching, and to rank the relevant responses, wherein the ranking of each relevant response is based at least partially on the position of one or more matched attributes of that relevant response within at least one ordered combination.

This application claims priority to U.S. Provisional Application Ser. No. 61/708,542, filed Oct. 1, 2012, which is incorporated by reference herein in its entirety for all purposes.

### FIELD OF THE INVENTION

The invention relates to searching information from databases.

### BACKGROUND TO THE INVENTION

It is known that searching and analysing large structured datasets, such as databases, for specific information is computationally expensive and that the information that is returned is often not relevant, or not what the user intended to be returned.

In the field of data warehousing, data is held as “structured data” such as by storing data in a relational database. Searching and analysing of this structured data is done by entering specific structured queries in an appropriate language such as by using SQL. It is important that the user is familiar with the content and context of a query, as well as understanding the precise language required for queries (e.g. SQL), otherwise the returned results are unlikely to contain the information that the user desires. If the query constraints are set too broadly, too many results can be received for the most relevant results to be found. If the query constraints are too restrictive then no results will be returned. This is because SQL is a based on “set theory” rather than a probabilistic approach.

One approach to searching is through the use of prescriptive, navigational or directory based searches in which a limited set of results are categorised and sub categorised so that a user can attempt to navigate by selecting preset categories in a preset order. It is known to apply this to structured data using what is often referred to as “multidimensional searching”. This enables a user to drill down through data by choosing between predefined routes through which data can be retrieved. This multidimensional searching does not require the expertise or precision of writing individual structured queries and allows for browsing around areas of interest, but it is considered rigid and restrictive. Further, the interfaces required are inefficient. For complex “slice and dice” operations, a user must make large numbers of choices from large numbers of options. The larger the dataset and the more numerous the categories, the more difficult it becomes to provide a physically efficient interface that gives the user both accuracy and speed in finding desired results.

It is also known to use “faceted searching” on semi-structured and occasionally on structured data. Faceted searching filters user input text in order to obtain relevant information along multiple dimensions. However, this only allows a user to follow prescribed paths and suffers many of the disadvantages of multi dimensional searching.

Unstructured data has a wider variety of searching tools and has traditionally been considered quite separately from structured data. For searching web pages, web directories have been produced to allow users to drill down to results, but more popular search engines also exist that are capable of responding to a freeform keyword search input by a user and returning relevant web pages in such a way that the most desirable web pages can be easily and quickly physically accessed by the user that inputs the query. These engines work by indexing webpages through links, matching keywords in the query to words in the data or metadata of the webpages and then using algorithms to rank for relevance and/or popularity.

Standard techniques used by web search engines typically require a query consisting of a string of words to be submitted, which is analysed in line with a series of algorithmic rules in the system. A first search of the content can be performed based on a series of criteria, such as the frequency of occurrence, the relevance of words and the nearness of related words in the query string. The results go through a process known as ‘soft filtering’, which removes data considered to be irrelevant. The filtered results are then subjected to an algorithmic reordering process.

Different search engines use different algorithmic reordering processes that may be based, for example, on the popularity of a particular page or dataset, or probabilistic interpretation of the query. Performing probabilistic statistics on large datasets requires a lot of computing power and is a complex process. Ranking based on the popularity of a particular page or dataset will not necessarily return the most appropriate result, since the user may require a particular piece of information in a search field, not necessarily the most popular piece of information in the search field.

From a user perspective the capability of finding relevant pages with non-prescriptive, simple, keyword searching of vast quantities of varying information leads to a very successful searching system, despite the lack of structure to the data. However, such engines have not conventionally been considered useful for structured data since they do not use structure as an input, and instead rely on the same words occurring in both the query and the indexed webpage that is to be returned to the user. Further, it is not apparent how the algorithmic reordering/ranking processes that are used by web search engines could be usefully applied to structured data that is not on the web, since the criteria such as number of links are not directly analogous to criteria that would be considered the most useful to the searching of structured data such as databases. Even if the raw data is indexed on the web, for analytics of structured data, where data needs to be compiled from different locations and/or calculations applied, to produce the results using conventional web search engines would not be of assistance.

### SUMMARY OF THE INVENTION

It is an objective to at least to mitigate at least some of the problems described above.

According to an embodiment of the invention, there may be provided a computer system for assisting searching of a database of a plurality of attributes, measures and content in order to answer analytical queries, the system comprising: an input device for receiving word queries requesting information and/or metrics from the database a processor configured to process word queries requesting information and/or metrics from the database; and a storage memory containing a plurality of responses to word queries which responses contain and/or correspond to attributes, content and/or measures of the database, and containing one or more ordered combinations of attributes and preferably at least one measure wherein the attributes/measure of the ordered combinations are in a set order, the processor configured to match one or more words in a received word query with one or more attribute, content and/or measure in the stored responses, to provide relevant responses to the input word query based on the matching, and to rank the relevant responses, wherein the ranking of each relevant response is based at least partially on the order of one or more of the matched attributes/measures/attributes that correspond to matched content of that relevant response within at least one ordered combination.

According to a further aspect of the invention, there may be provided a method of searching a database of a plurality of attributes, a plurality of fact measures and a plurality of facts, comprising: entering a search query comprising a string of groups of characters; matching at least one of the groups of characters in the search query to at least one of the plurality of attributes stored in the database; preferentially ranking a summary of content combinations containing at least one attribute in accordance with at least one hierarchical domain stored in the storage memory, the hierarchical domain comprising an ordered list of decreasingly preferred attributes; and displaying the ranked plurality of information.

Embodiments of the invention are described, by way of example only, with reference to the following drawings and the detailed description.

### BRIEF DESCRIPTION OF THE FIGURES

FIG. 1 is a diagram of hardware apparatus;

FIG. 2 is a flowchart showing steps involved in searching a structured database;

FIG. 3 is an schematic illustration of part of a result set;

FIG. 4 is an example of a single hierarchical dimension;

FIG. 5 is an example of two separate single hierarchical dimensions and ranking resulting from a query;

FIG. 6 is an example of two hierarchical dimensions;

FIG. 7 shows examples of four domains;

FIG. 8 shows tables representing ranked results

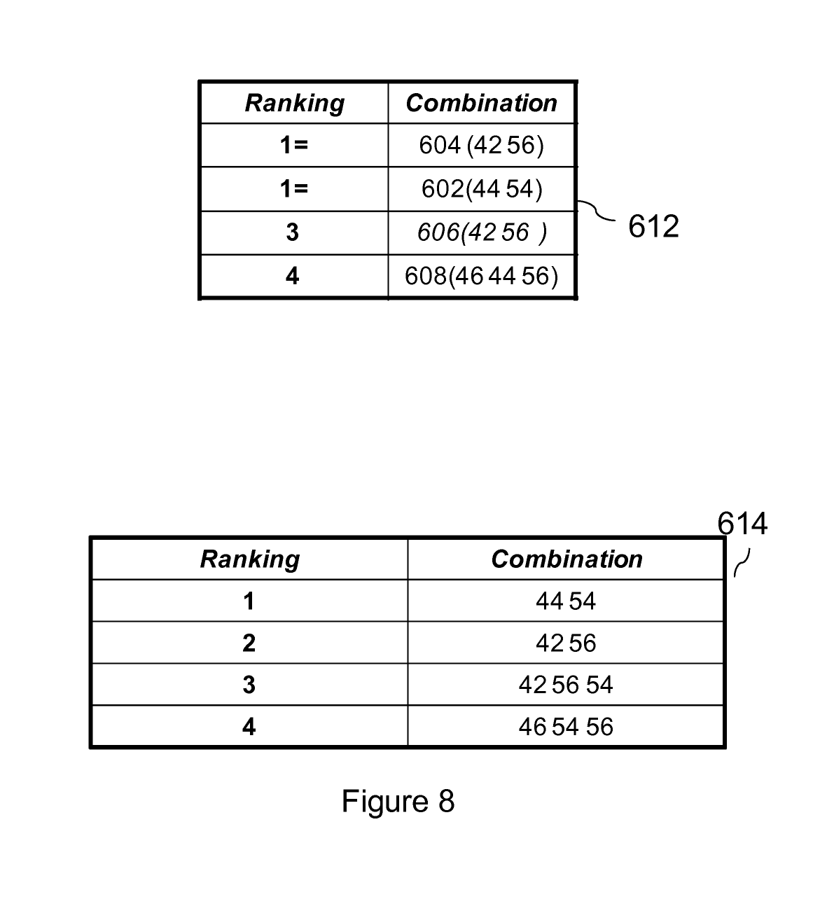

FIG. 9 is a depiction of charts relating to or forming part of a result set;

FIG. 9b is a depiction of a chart;

FIG. 10 is an example of two hierarchical dimensions;

FIG. 11 shows tables representing ranked results; and

FIG. 12 shows examples of domains and ranked results where domain access is different for different users.

### DETAILED DESCRIPTION OF AN EMBODIMENT

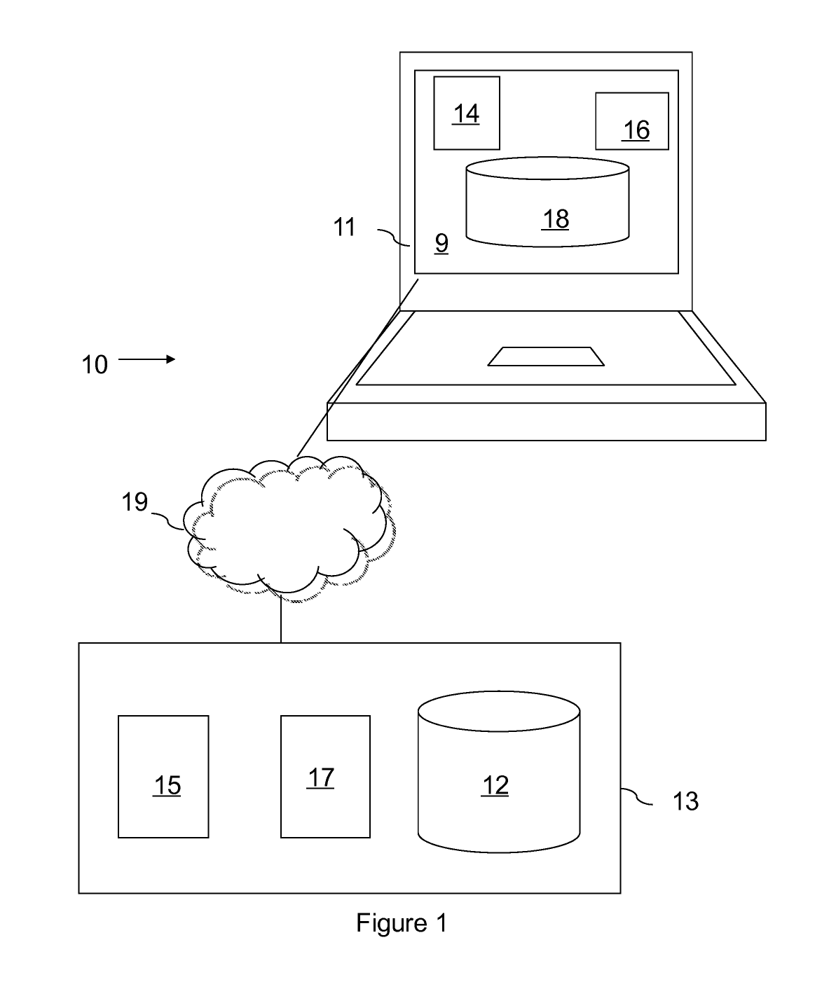

FIG. 1 is a diagram showing hardware apparatus in accordance with at least an aspect of the invention. Searching of a database 12 is performed through a computing apparatus 11. The computing apparatus 11 comprises RAM 14, a processor 16 and non transitory data storage 18 which may be, for example, a hard disk. The computing apparatus 11 is connected via a network 19, to a server 13, which comprises the database 12, as well as RAM 15 and a processor 17. The computing apparatus 11 also comprises a display 9.

In the example shown, there is one database 12. However, in further examples there may be more than one database 12, which can be accessed by the computing apparatus 11 through the network 19. Advantageously, this allows searching across multiple databases 12, which may be positioned in different locations and/or updated independently of one another. In further examples there are multiple servers 13 that the computing apparatus 11 can access through the network 19. In the example shown, the network 19 is a local network, however, the network 19 may be the internet.

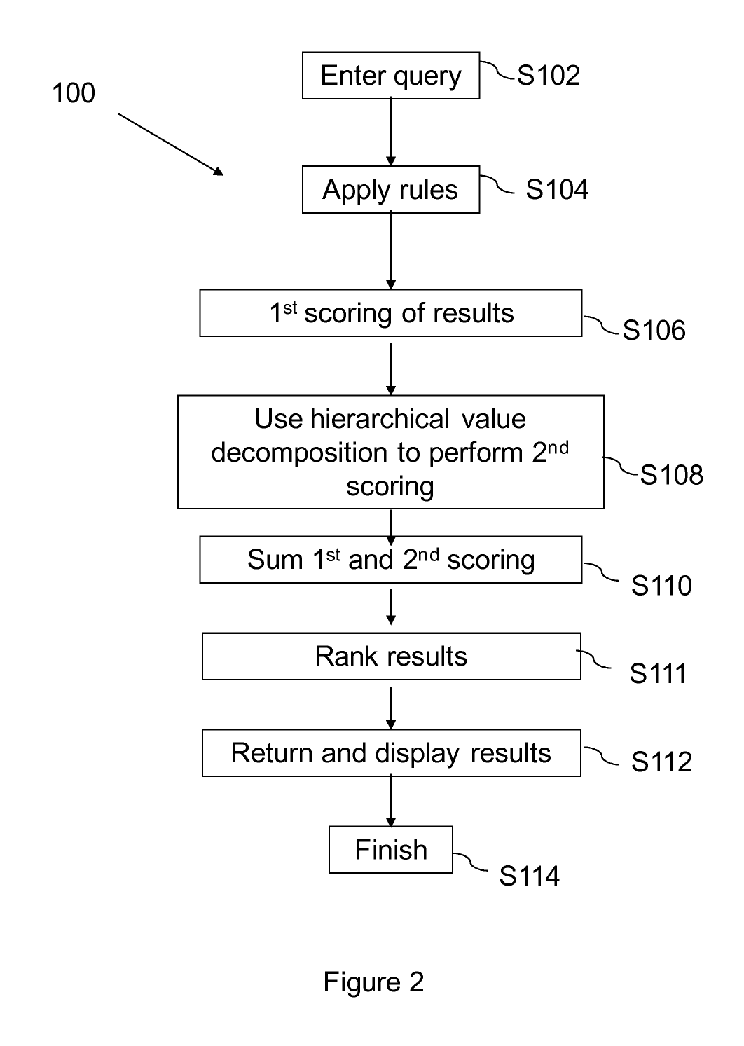

In FIG. 2 is a flowchart showing a process 100 of a user searching a database 12 using processor 17.

Before any user steps, a result set to be searched is compiled. Unlike SQL queries, user queries using the process 100 are preferably not applied directly on the structured data such as a relational database. Knowledge of the attributes, facts and/or measures that are associated with the database 12 may be automatically generated by processor 17 from reading the database or entered manually, or a combination of the two. The results to be searched can then be generated from this knowledge. Every possible combination of known attribute, fact or measure can be generated by processor 17, or a smaller list, or only the plausible or desirable combinations, may be generated such by applying user input constraints and/or the referring to the domains discussed below.

The result set to be searched may be a list of all possible/plausible/desirable structured queries that have been formatted and written in the correct format in accordance with an appropriate query language such as SQL. Once process 100 (described below) is completed, the user is then presented with relevant structured queries based on their input keywords and user selection of the most desirable of those structured query can result in it being automatically applied to the database 12 to return one or more answers.

It is preferable, however, for the results set to be searched to be a list of all possible/plausible/desirable answers to (possibly hypothetical) user queries constructed from the available combinations of attributes, facts and/or measures. These answers may be provided in the form of titled charts that display the data in visual form and are suitably titled, such as with the structured query that they answer. These can be, for example, bar charts showing one or more metrics relating to certain attributes or database content.

This preferable approach has numerous advantages. Amongst the advantages is that the user that enters the search query is provided with answers more rapidly without major computation having to be applied after process 100 is complete. Additionally the user can browse through all of the highly ranked charts looking for interesting looking results or shapes, rather than browse through an abstract set of structured queries. A disadvantage of including answers rather than structured queries in the results can be that if conventional relational database and queries are used directly (such as SQL queries with a relational database management system), then to produce each result from a query can be computationally intensive, especially if joins are required across multiple tables. If the number of users is low and the number of possible queries is high, running all queries in advance of process 100 may be inefficient. This disadvantage may be overcome by using the system described in European Patent Application EP 2164007 and US 2010/0094864 A1 (which is incorporated by reference) whereby a large number of answers can be produced easily, efficiently and near simultaneously in advance of a user entering a free from query at step S102.

The result set to be searched is stored in local data storage 18 and hierarchical dimensions that are extracted and domains produced in the manner described later are also stored in data storage 18. Once this is complete then queries using process 100 can be commenced at which point much or all of this data may be transferred into the RAM 14. At step S102, a query is entered in to a computing apparatus 11 by a user. The search query that is entered comprises a string of groups of characters. The order of the groups of characters in the search query is not prescribed but the query should be in the context of the data that is being searched. That is to say that the search query should be related to the content of information that is stored in the database 12, in order to return meaningful results. However it may be entered in free from rather than in accordance with any structure or query language. Once the search query has been entered into the computer system, the process can move to the next step S104. Preferably the groups of characters entered at this stage are words, however, in other examples the groups of characters comprise numbers, symbols, or any other relevant and searchable characters. The groups of characters correspond to attributes, content or (fact) measures. Attributes are specifications defining an object, element or file e.g. “City”. Content is data that can be processed, stored or transmitted that belongs to an attribute e.g., “London”. Fact measures or simply “measures” are properties on which calculations can be made such as sum, count, average, minimum, maximum to produce a metric. Most desirable search queries will include at least one measure and at least one attribute or item of content.

At step S104, a set of axiomatic rules are applied. These rules determine the content of the search query that will actually be searched. Stop-words are removed from the search query. The stop-words are a pre-defined set of words that are considered to be superfluous to the content that is to be searched. Examples of stop-words are ‘the’ and ‘by’, although the user can determine any words, or groups of characters, that are to be ignored for searching purposes, if they are deemed to be unsuitable for returning meaningful data. Similarly grammatical punctuation can be removed from the search query, as appropriate.

At step S104, other rules may be applied. The process may be used to determine equivalent words that are being searched, such that the terminology used in the database is adhered to. For example, if a query is submitted for the ‘number of calls by team’ and the data is stored by ‘group’ instead of ‘team’, but the two words are known to be semantically equivalent, then this can be incorporated into the search rules, such that alternate, relevant, information is returned.

Context dependent words can be removed from the search query if they are considered to be unimportant. For example, in some cases, the characters ‘it’ are considered to form a word that may be an unimportant pronoun, in other cases they are considered to be an abbreviation of ‘information technology’ and relevant to the search query. The removal or acceptance of such groups of characters in the query can dependent on the rules applied at this stage and may be dependent on the other words present in the query and/or the data in database 12.

At step S106, a first search and scoring is performed by comparing the (possibly adjusted) search query with the results in the result set rather than any direct comparison with the structured contents of the database 12. Once the query has been established, the first search and scoring involves assessing the information in the result set and retrieving matched information. Each word of an entry in the result set that has at least one group of characters in it that is the same as a group of characters in the search query, has a sufficient match to at least be given a score. If there is no common group of characters in the search query and in the information in the result set, no score will be returned. Each search result in the result set is scored based on a number of algorithmic rules that are determined in relation to the search query. The algorithmic rules may include calculating the frequency of groups of characters in the search query, the nearness of the groups of characters to one another and/or the relevance of each group of characters and comparing this to the returned data entries. The apportioned score for each rule results in a total score for each search result. For example, a search query that contains the same words as a search result, in the same order, will score higher than a search query that contains the same words as a search result, where the words are in a different order.

At this stage, all of the search results in the result set are scored. A second stage of scoring is performed at step S108 on either all of the search results, or a selected number of the highest scoring search results. Advantageously, by using a selected number of the highest scoring search results on which to perform the second scoring, the computational requirements are lowered and the system is thus more efficient.

At step S108, what will be referred to as hierarchical value decomposition is used to perform a second scoring of the data. This stage takes the initially scored results from the first search and applies a further algorithm based on at least one domain and/or dimension hierarchy that is defined prior to the search being performed. Each domain contains a list of decreasingly preferred attributes of database 12 (or other groups of characters), which relate to a query/result and are such that the attribute at the start of the domain is considered to be the most important and the attribute at the end is considered to be the least important. Similarly dimension hierarchies comprise an ordered list of attributes (or other groups of characters) where the attribute at the top of the hierarchy is considered to be the most important and the attribute at the bottom is considered to be the least important. The second scoring is preferably initially independent of the first scoring so that the second score allocated to a result in the result set during the first search (except that results with low first scores may be filtered out before the second scoring as described above).

The hierarchical dimensions and domains provide a way to score each of the search results that have been selected following the first search and scoring. A number of rules are applied, with each rule resulting in a contribution to the scoring process. The rules are selected to ensure that the scoring reflects that the highest scores are attributed to the search result that is most relevant to the search query and that is appropriate for the context of the search query. An example of a rule is that the more relevant a word is, the higher it will be in a hierarchy and thus the higher score it will have attributed to it. For example, each word, or character group in a data entry, is compared with the character groups or words in the hierarchical dimensions and domains. Irrespective of the ordinal position of the word or character group in the query, positive matches between the words or character groups in the query and those in the hierarchical dimension or domain will result in a score being returned. Cumulative scoring of the words or character groups in a data entry result in a score being attributed to the data entry, in respect of the hierarchical dimension or domain that is being applied to it.

Once the hierarchical dimensions and domains have been applied, the process moves to step S110.

At step S110, the scores from the first search and scoring are combined with the scores from the second scoring to produce an overall score for each of the search results scored at step S108. At step S111, the search results are ranked in the order of the overall scores, starting with the highest score. For results that have the same score, additional unmatched character groups or words present in the search result that are not present in the query are used to differentiate between the results with the same score. The more additional unmatched character groups or words that are present in a search result, the less relevant the result is considered to be and the more lowly they are ranked.

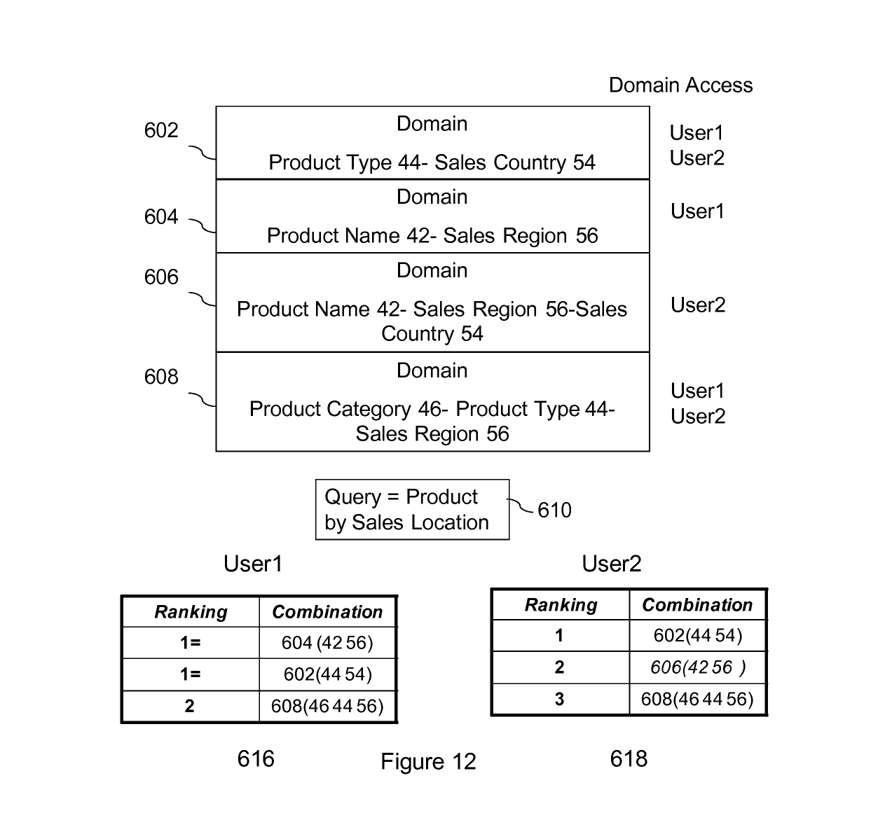

The results are returned at step S112 and are displayed on display 9. The results can be displayed in the form of charts. In an example, the charts are displayed in a carousel (such as that shown in FIG. 12 of US 2010/0094864) on display 9, whereby the relative position in the carousel displayed at display 9 corresponds to the ranked position and the user can navigate through the ranked position by rotating the displayed carousel.

The results carousel contains the results view of each of the query results. By using arrow keys a user can move between these various graphs in the carousel representing all the query results in the filtered set, placing any of the desired nine at the front with the corresponding textual description moving or being highlighted alongside.

The user can rotate the carousel in order to move between the search results to find the desired graph. Even if only part of the required information for a particular query has been entered (for example the user may not know the correct name for the type of measure he wishes to analyse) the desired query can be part of the result set and therefore easily found. Even if the desired query is the one initially shown at the front, the carousel also allows the user to compare it to other query results. Additionally a user can scan through many similar/related analytics on a carousel looking for interesting or unexpectedly shaped graphs and then analyse these further.

At step S114, the process finishes. Further searches can now be performed. In some embodiments, the search criteria can be further narrowed by employing more limitations to the search query. This allows for further filtering and distillation of results.

In a further example, where the same scores are returned for some results at step S111, those results may be arbitrarily displayed in an order, or further ranking rules may be applied in order to differentiate between the order of results that are returned.

The fact measures relating to a search result can be scored in the same way as another relevant word in result in the result set. Consequently if a character group in the search query matches the fact measure contained in the results then this will contribute positively to the first score in step S106 in a similar manner to a matching attribute. In cases where positive matches are made between fact measures in a result and keywords as part of the rules pertaining to the first scoring, these will contribute to the higher ranking of a result. The fact measures present in the search query and/or the results need not contribute towards the second score at step S109. However, where there are unmatched fact measures present, whilst these will not contribute to the scoring at S106 and S108, for cases where search results are returned with the same scores after the summation of scores at S110, the more unmatched fact measures present in the search result, the lower it will score relative to other search results that received the same score at S110, but which have less unmatched fact measures as with any other relevant unmatched word.

Examples of the concepts involved in the first pass ranking of returned search query data content are occurrence, nearness and relevance. These are interrelated algorithms that are used to produce a first scoring of returned data from a search query of a database 12.

In a string of groups of characters in a search query, each group of characters, which is preferably a word, has a frequency of occurrence in the string of the group of characters/attribute. In an example, a query has five groups of characters/attributes, labelled A, B, A, D and E. The groups of characters B, D and E occur with a frequency of 1, the group of characters A occurs with a frequency of 2. This is a measure of the importance of the group of characters, or word, in the query. For example, the group of characters C is not in the search query, and therefore has an occurrence frequency of 0 and is not considered important for the first search of the database 12.

In a string of groups of characters in a search query, the relative position of the groups of characters to one another may have a bearing on the interpretation of the intended meaning of the user. For example, if the user made a query such as: ‘number of calls by call type by team’ it is evident that the ‘number of teams’ is not a desired attribute in the request, rather ‘number of calls’ is the desired attribute. A score of this nearness such that the closer the groups of characters are to one another the higher the importance of the combination of those groups of characters can be made. For example for a query with five groups of characters labelled A, B, C, D and E, a combination of B and D found in an entry in the result set will have more significance than a combination of A and E, where the lower the number, the more significant the combination of the groups of characters.

The relevance of a particular combination of groups of characters or words found in the database 12 may be scored in many different ways. It can be defined as a ranking of a score of the nearness that was previously shown. For example for a query with the groups of characters labelled A, B, C, D and E the nearness of (A and B) is the same as (B and C), (C and D), and (D and E), which is greater than (A and C), (B and D) and (C and E), which is greater than (A and D) and (B and E), which is greater than (A and E).

In further examples, the relevance of a particular combination of a group of characters is based on the occurrence of each group of characters. The more frequently the group of characters occurs, the more relevant the result.

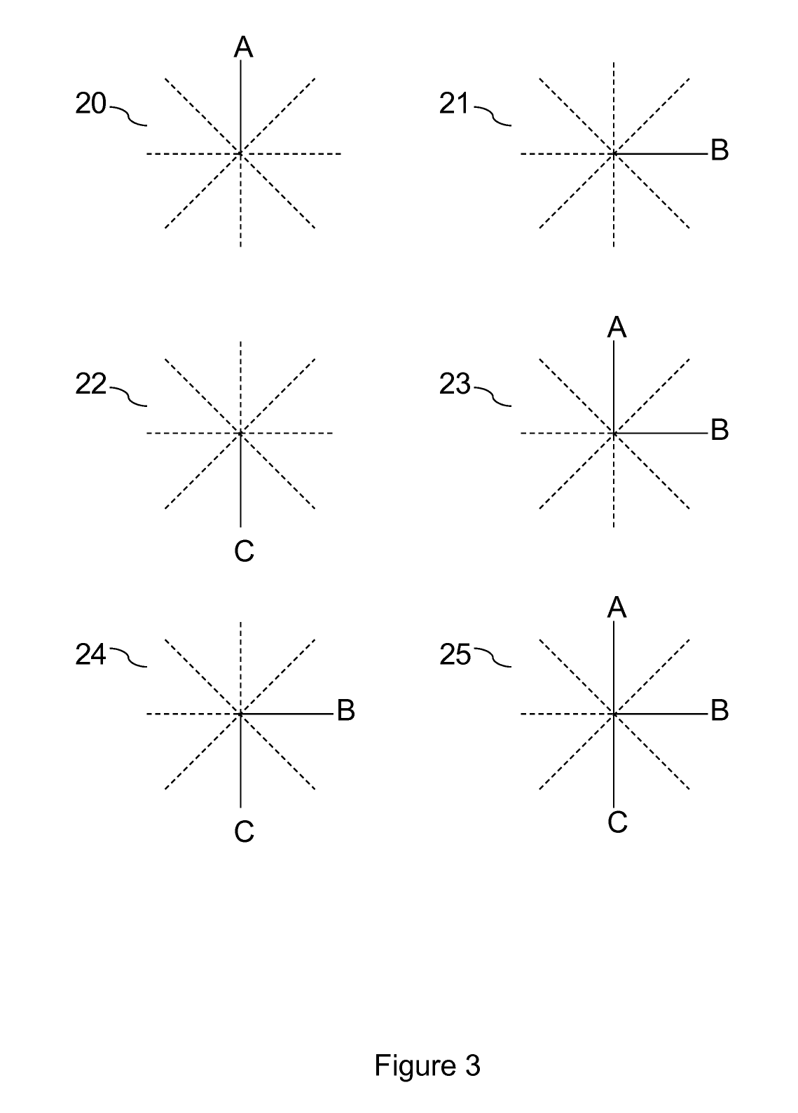

FIG. 3 is a graphical representation of the result set based on data found in a database 12 and is made in order to facilitate understanding of the searching process. FIG. 3 relates to a search query consisting of three groups of characters, A, B and C. Each of the representations in FIG. 3 relates to a result item, consisting of numerous elements of information, stored in a database 12. In the example, a data item 20 is shown containing the group of characters A. There are a number of lines, each corresponding to a group of characters that may be representative of an attribute, item of content, or fact measure. There are eight intersecting lines that are shown in each of the graphical representations 20, 21, 22, 23, 24 and 25, however, in further examples the number of intersecting information elements in a data item is unlimited. In the example, a second data item 21 is shown containing the group of characters B amongst other elements of information. Similarly, a data item 22 is shown containing the group of characters C amongst other information elements. Data item 23 is shown containing both groups of characters A and B, amongst other information elements. Data item 24 is shown containing groups of characters B and C, amongst other information elements. Data item 25 is shown containing all groups of characters A, B and C, amongst other information elements.

As described above these results preferably represent actual titled charts that answer a query but may instead be a structured query written in the correct warehouse to run in a data warehouse. So for example if A—was a measure “average”, B an attribute “Sales” and C and attribute “City”—result 25 may be a structured query to ask for the average sales by city or a bar chart with a bar for each city that occurs as content under the city attribute and with each bar illustrating average sales (the quantity of which can be read from a vertical or horizontal axis). The titled charts are displayed on display 9. In an example the charts are displayed in carousel form, whereby the order of the charts in the carousel indicates the ranked position of the chart in response to a query and the user can navigate the ranked results by rotating the carousel displayed on display 9.

Each of the combinations of the groups of characters A, B and C found in the search query are present in the initial result set obtained from the data in database 12. They may furthermore be associated with numerous combinations of information elements. Consequently, there may be a large number of items in the result set that have a single group of characters from a search query and there may be less data items that have a higher number of the groups of characters from the search query. The frequency with which each group of characters appears in a data item, with any number of other information elements, is not as important as the number of intersections of groups of characters that are found within each data item.

Preferably, each combination of information elements provided may be considered to be a potential answer to a input search query rather than just a structured query in the correct format to find the answer form the data warehouse. These combinations can be meta-tagged and preferably stored in-memory (such as in RAM 14) as well as in data storage 18 to increase the speed of the operation. When a query is searched, the results are effectively ready to be returned, based upon the ranking mechanism. This increases the efficiency of computation of results. An example of such potential answers being stored in-memory is given in European Patent Application EP 2164007 A1, whereby data values belonging to a plurality of attributes are stored in the database 12, where there is a linear entry/group of two or more collections of data belonging to a base attribute of the plurality of attributes, each collection of data corresponding to the same value of a base attribute and comprising a data value belonging to an attribute associated with the base attribute, as well as an attribute identifier corresponding to the attribute associated with the base attribute, and an identifying data value belonging to the base attribute or being stored in a location relative to one or more other collections of data from which location an identifying data value belonging to the base attribute can be determined. Advantageously, this allows the data to be read from multiple databases 12 without the need to read across, and join together, those databases 12, which can be computationally expensive and thus take a long time.

In further examples, the data is not stored in-memory and an algorithm is employed to effectively perform the stage of tagging the data prior to performing the search and returning the results. This is advantageous in circumstances where data has not been appropriately tagged and searching needs to take place on already established relational databases.

A dimension is a set of related attributes, for example: “sales region”, “sales country”, “sales province” are all attributes which can contain different content but relate to an overarching concept of location of a sale. All attributes that belong to this overarching content will be placed in the same dimension. Each attribute can be further broken down into the content that relates to them which can also be a discrete list; for example, the content for “sales country” might be UK, France, and Germany under the ‘sales region” Europe and might be Japan, Korea under the “sales region” Asia. The content for “sales province” might be Kent, Essex, Sussex under sales country “UK”. Ordinarily the content is not given a hierarchical order, only the attributes that form a dimension are ordered and are constructed but content can be manually ranked if it is useful to do so and some items of content are believed to be more interesting or important for users to analyse than others.

Dimensions and the order of the hierarchy can be derived from the structure/schema of database 12 and are inherent to its structure/schema and/or derivable from metadata. The order of hierarchies in dimensions in data warehouses is well understood.

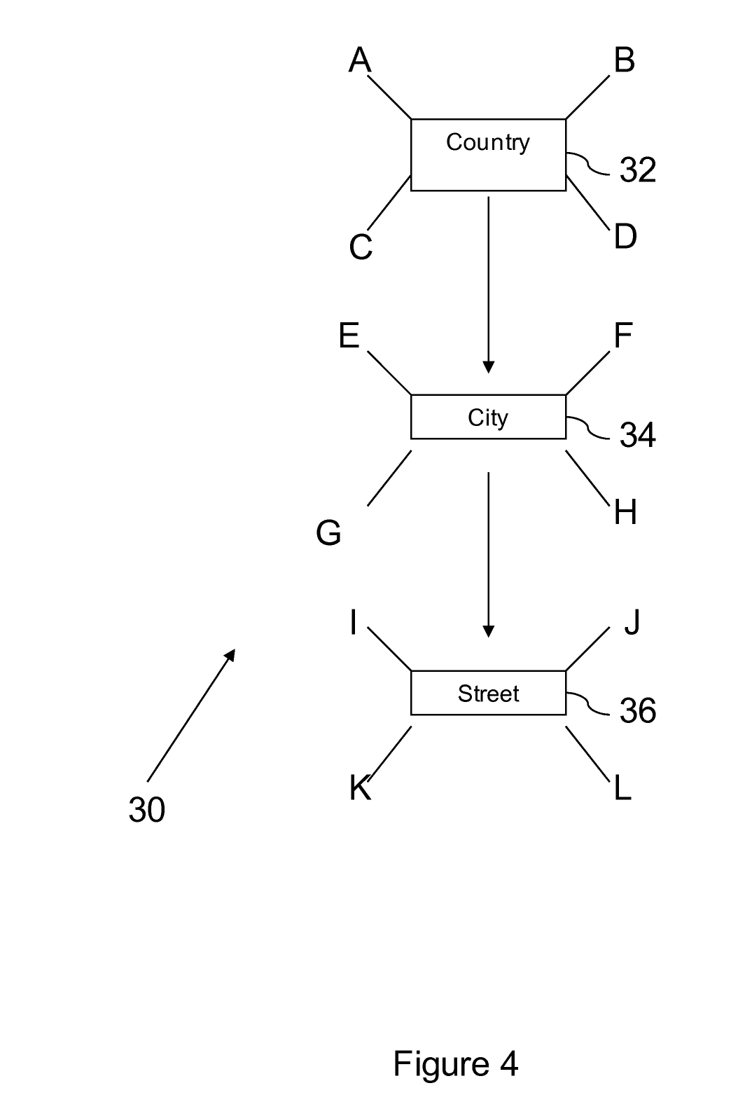

FIG. 4 shows a simple example of a single dimension hierarchy 30 relating to a location. The ranking in the dimension is such that the attribute country 32 ranks more highly than city 34, which ranks more highly than street 36. There will be data items of content stored in a database 12 relating to each of the attributes 32, 34 and 36. These are labelled A, B, C, D in relation to country 32; there may, however, be any number of associated data items related to the country 32. The data items related to city 34 are labelled E, F, G, H, but again there may be any number of data items related to city 34. Finally, data items relating to street name 36 are labelled I, J, K and L, but there may be any number of data items related to street 36.

A query may request a content fact relating to an attribute rather than an attribute itself, for example, instead of “the number of patients by city” 34 or “the number of patients by street” 36 the query could be phrased ‘the number of patients in London’. Now the result set from which results in Step S114 are provided may include charts or structured queries for “the number of patients by city” 34 and “the number of patients by street” and the number of people in each of content items E, F, G, H and I, J, K and L. The query phrased ‘the number of patients in London’ may be considered ambiguous, since ‘London’ could be both a City E (Greater London) as an entry for the attribute city 34 and a part of a street name K belonging to an attribute 36, e.g. ‘London Road’, with vastly differing populations. The query is matched for words for the result (e.g. chart or structured query) ‘the number of patients in City A (Greater London)’ and the result ‘the number of patients in Street G (London Road)’. However the order of the ranking of the relevant attributes in the dimensions hierarchy 30 can be used to differently score these two results so that the order of the hierarchy determines which of the returned result achieves a higher score during the second scoring S108 (and therefore may ultimately result in a higher final ranking at step S111). Therefore the number of people in Greater London would be scored above the number of people in London Road in this case because its associated attribute—City 34 is higher ranked than the attribute Street 36.

Further complications arise where ‘London Road’ is not a unique street name. Therefore user queries requesting ‘the number of people in London Road’ can be improved by specifying the city name attribute. For example ‘the number of people in London Road, Southampton’ will differentiate between “London Road, Southampton” and, for example, “London Road, Brighton”. This differentiation will occur because of the rules applied at first scoring and not necessarily because of the order in the hierarchical dimension 30. This is because, in this case, there may be a Southampton Road in London, as well as a London Road in Southampton.

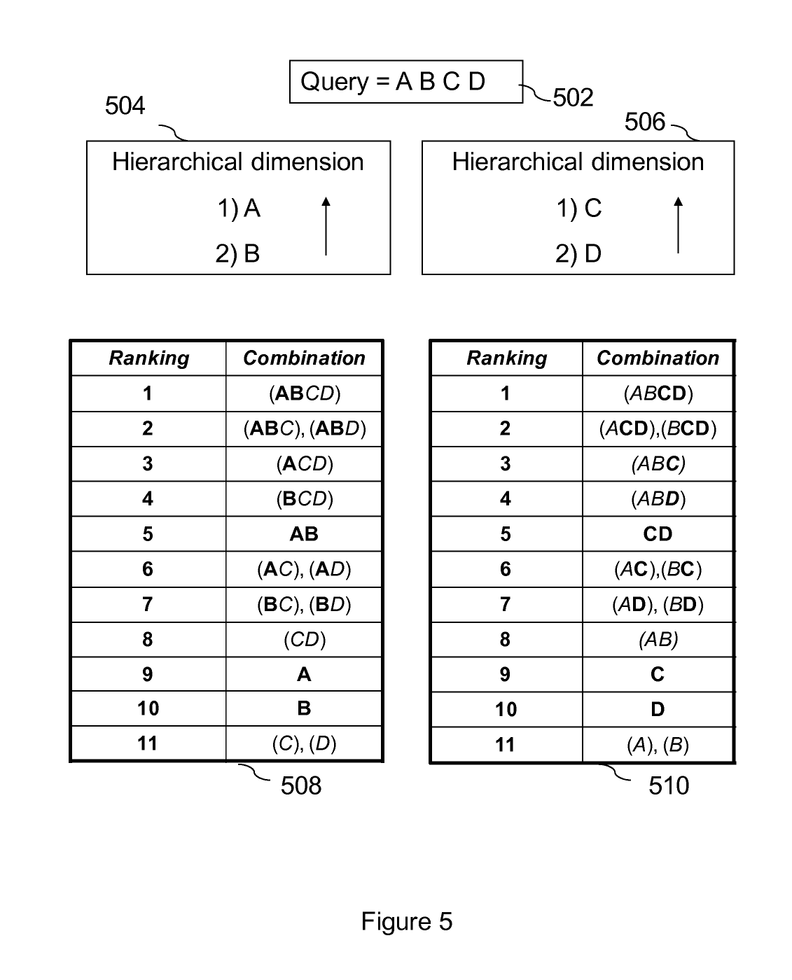

If the query simply requested ‘the number of patients’, there may be data relating to the number of people in a number of countries, cities and streets. The second score and therefore final ranking of the result s that will be returned can be affected based on the hierarchical dimension 30. Using the order of dimension 30 the number of people by country 32 will score more highly than the number of people by city 34 during step S108, which in turn will score more highly than the number of people by street 36. For each further subdivision of attribute, the subsequent ranking is dependent on the relevance of the searched term in the query, from the set of algorithmic rules passed at the first ranking. For example, if the query was ‘number of patients that are male’, it has had a further limitation placed upon it; data items with information pertaining to gender will provide a factor that influences the relevance of results in the first score. Data items containing ‘male’ will rank more highly. The second scoring that employs the hierarchical dimension will allow for more refined final ranking. In this case, data items relating to the number of male people by country 32 will score more highly than the number of male people by city 34, which in turn score more highly than the number of male people by street 36. Furthermore, these data items will score more highly than the number of people by country 32, then city 34, then street 36. Ranking by the order of a dimension alone is found to be non-optimal in most situations such as where the query may match attributes from multiple dimensions. FIG. 5 is an example of a query 502, which consists of four groups of characters, A, B, C and D. Two hierarchical dimensions 504 and 506 are defined. In this example, the letter labelled 1 is considered to be higher in the hierarchy than the letter labelled 2. The letters in the hierarchical domains 504 and 506 are attributes. These letters represent the same groups of characters with the same labelling in the query 502. That is to say ‘A’ and ‘B’ in hierarchical domain 504 are the same as ‘A’ and ‘B’ in query 502 and ‘C’ and ‘D’ in hierarchical domain 506 are the same as ‘C’ and ‘D’ in query 502, for the purpose of illustration.

Below each of the hierarchical dimensions of FIG. 5 there is a table 508, 510 illustrating a ranking. The ranking of table 508 corresponds to the hierarchical dimension 504 and the ranking of table 510 corresponds to the hierarchical dimension 506

In both of the examples shown in FIG. 5, there are two sets of ranking stages that have been passed in order to obtain the ranking that is shown. It is first necessary to consider the results that such a query 502 might return. There are four groups of characters and relevant data in a database may contain a group of characters relating to at least one of the four groups of characters seen in search query 502. The relevant data may also contain information beyond the relevant characters. Such data alters the number hits that might be obtained relating to a combination of the groups of characters in query 502. Fundamentally, in this example, there are fifteen combinations, or intersections, of characters that could be found in a database and therefore a full result set: ABCD, ABC, ABD, ACD, BCD, AB, AC, AD, BC, BD, CD, A, B, C and D. There may be further data values, for example AD+X, BC+Y and so on, however, for ease of explanation, the extra groups of characters, such as X and Y, are left out of these examples.

The first pass ranking in the example of FIG. 5 is performed based on the occurrence of the groups of characters in the query 502. Therefore, data in the database that contains all 4 of these groups of characters is considered to be more relevant than the data containing only three of the groups of characters in the query. Hence ABCD ranks higher than ABC (for example, receiving the respective scores 40 and 30), which in turn ranks higher than AB (which, for example, receives a score of 20), and so on. Any combination of groups of characters in a data item in the database that has the same number of groups of characters as another data item initially receives the same score (for example, ABC and ACD have the same score of 30), however, in further examples, there is a greater degree of ranking based on the algorithmic rules that are employed at this stage.

The second pass scoring employs the hierarchical dimension for applying a score to each search result in the set of search results. In the case of hierarchical domain 504, any data item containing the group of characters A will rank higher than any data item containing the group of characters B (for example, A will score 0.1 and B will score 0.01 for this stage of second scoring). Subsequently, whilst maintaining the first pass ranking as an initial structure, more detailed ranking is applied to the list. This is done by summing the score of the first scoring with the score of the second scoring. In the present example, the presence of A and B in a data item will rank it more highly than a data item containing solely A, and the presence of A in a data item will rank it more highly than a data item containing solely B. The presence of B in a data item will rank it more highly than a data item that contains neither A nor B. For the purpose of showing how the ranking occurs, the following scoring is used: ABCD scores 40 at the first scoring, ABC, ABD, ACD and BCD score 30 at the first scoring, AB, AC, AD, BC, BD and CD score 20 at the first scoring and A, B, C and D score 10 at the first scoring. In the example, at the second scoring, ABCD, ABC, ABD and AB score 0.11, ACD, AC, AD and A score 0.1, BCD, BC, BD and B score 0.01 and CD, C and D score 0. By summing the results of the first scoring and the second scoring, ABCD scores 40.11, ABC and ABD score 30.11, ACD scores 30.1, BCD scores 30.01, AB scores 20.11, AC and AD score 20.1, BC and BD score 10.01, CD scores 20, A scores 10.1, B scores 10.01 and C and D score 10. These scores are reflected in the rank of table 508. Similarly, if C is given a score of 0.1 instead of A and D is given a score of 0.01 instead of B, the ranking changes to that seen in table 510.

As can be seen ranking by dimensions alone gives different results depending on which hierarchy is used to rank. Instead embodiments preferably use chosen “domains” as well as dimensions.

In contrast to dimensions it can be most desirable for domains to be defined by an human expert user familiar with the database 12, the needs of the end user who will enter queries at step S102, and the results that such end users desire or expect to be returned at step S112.

Domains are ordered as with dimensions and may alternatively contain (fact measures as well as attributes. Domains are constructed to mirror the result set from which results will be returned at step S114. For example if the expert user concludes that the end users may wish to see the result—“Measure of sales by product type by sales country” then they will construct a domain listing those attributes in that order which will be stored in local data storage 18. Each combination of attributes (and possible measures) for which it is desired to have corresponding results (be they charts or structured queries) ranked adequately in step S114 is preferably entered as a domain. To save time and processing power processing results that will never be highly ranked the result set may be based only on measures/attributes, which equate to an entered domain stored in data storage 18. However it is generally not necessary for desired domains to be entered for every individual result because results that are stored, ranked and returned which corresponding to specific content entries of an attribute can be automatically produced from a dimension that lists an attribute. So the entered domain of “Measure of sales by product type by sales country” can be used to produce results not just for that specific query but also “Average price of sales by product type by UK” “Sum of sales by product type by France” etc.

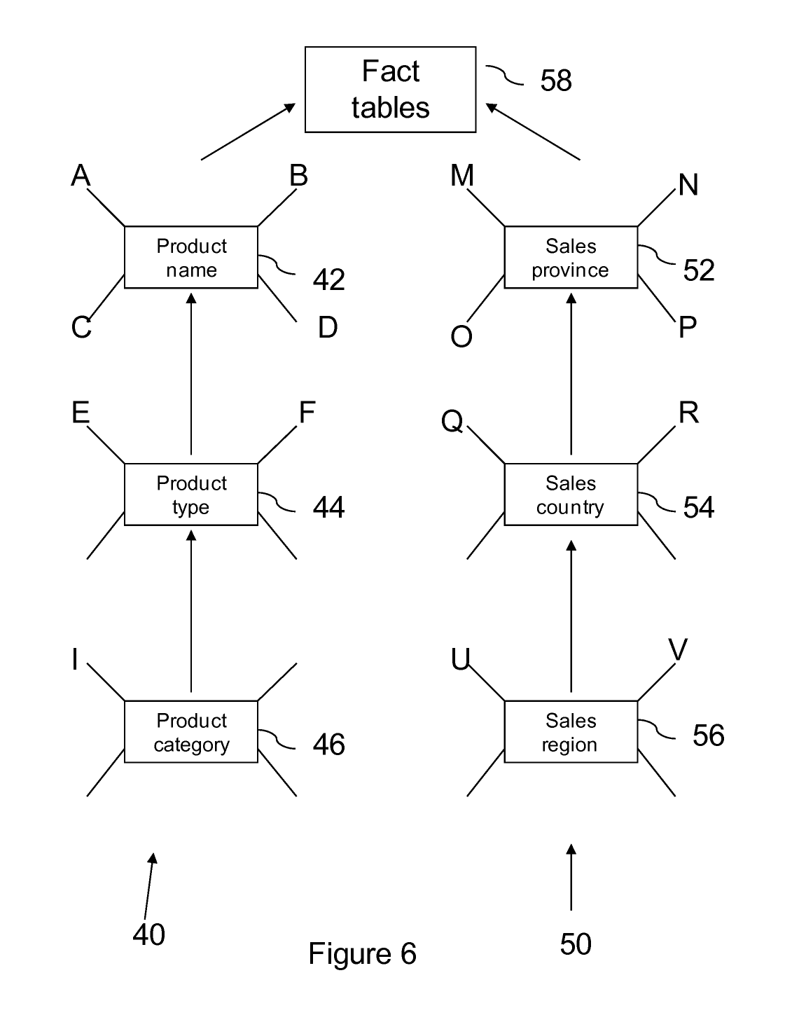

FIG. 6 shows fact tables 58 that are fed by multi-dimension data information. There are two dimensions shown, relating to product dimension 40 and sales location dimension 50. The attributes in each dimension are ranked. Product category 46 is ranked above product type 44, which is ranked above product name 42. Sales region 56 ranked above sales country 54, which is ranked above sales province 52. Each attribute has associated content. In this case the order of the attributes in a dimension follows logically—with the more generic attributes highest and the more specific attributes lower. In this example, four pieces of content are shown for each of the lowest attributes, two for the middle attributes and one or two for the highest attribute (A, B, C, D for product name 42 E, F for Product Type, I for Product Category, M, N, O, P for sales province, Q, R for Sale country and U, V for sale region). In this example, each piece of content can scored by relevance from this first pass ranking and this relevance is illustrated, by way of example, using its alphabetic position. Hence, A is scored higher than B, which is scored higher than C, which is scored higher than D.

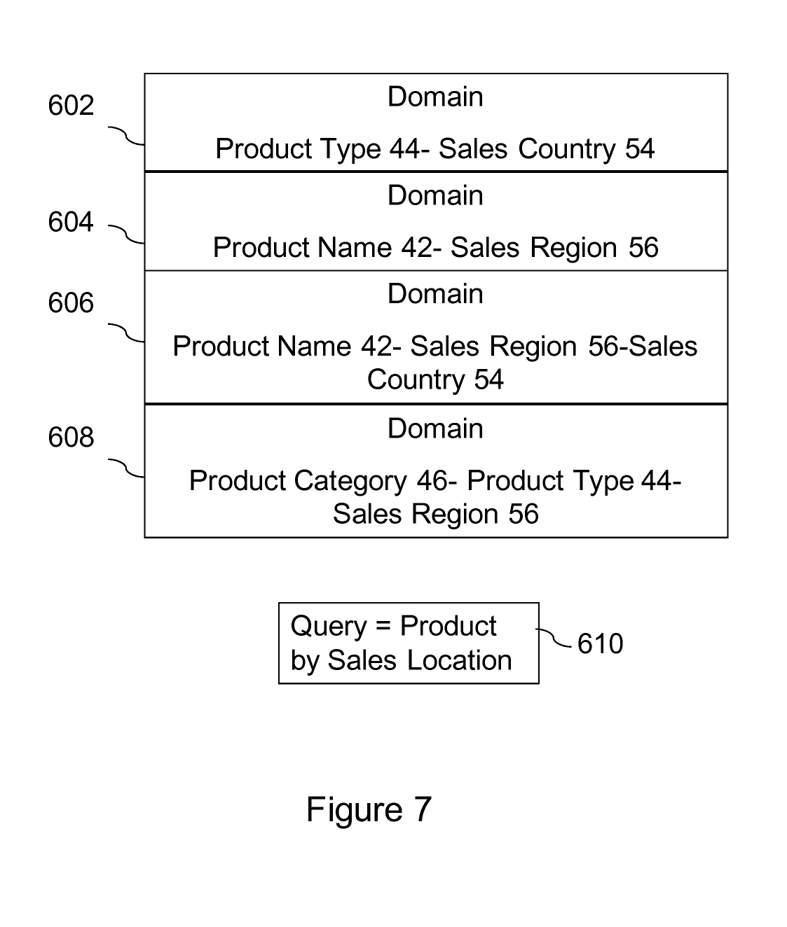

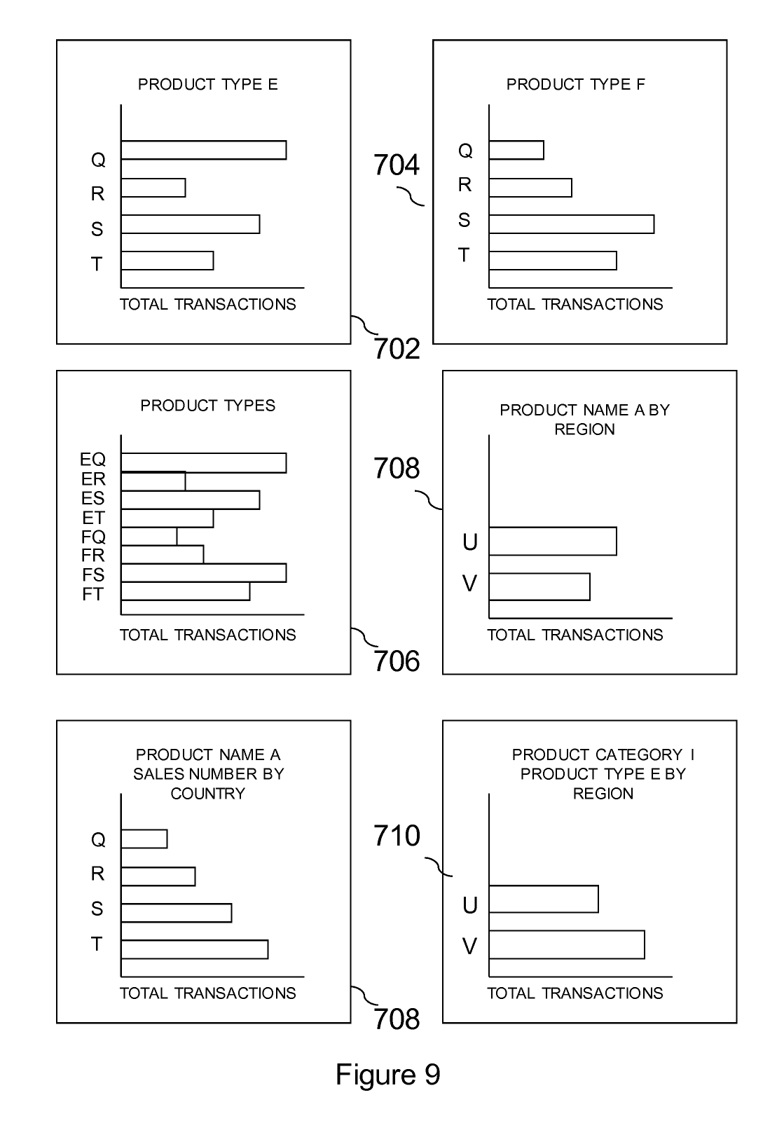

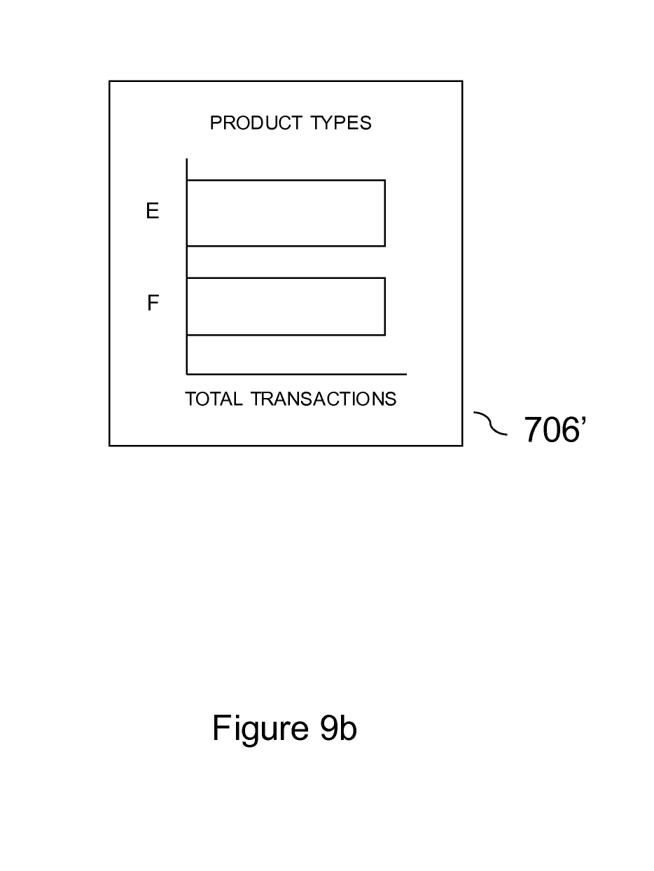

In FIG. 7 is shown four domains 602, 604, 606 and 608 that an expert user has configured for use with the dimensions of FIG. 6 and a query 610 entered by a user at step S102. In most practical situations most user queries, desired results and hence domains will contain a fact measure as well as attributes as the user will wish to view a particular metric, such as average or maximum sale prices, that is calculated using a measure. For ease of illustration in FIG. 7, a user query is shown that only include attributes and not a measure and FIG. 9 is illustrated with all results/charts having the same measure. This could be the case if for example there is only one metric of interest (e.g. total number of transactions) and this need not form part of the query or the ranking process. The illustration in FIG. 7 will be described with the metric being total number of transactions and not needing to be included in the query.

Domain 602 is an ordered sequence of two attributes—first product type 44 and then sales country 54. The order is significant as one or more results in the result set will be generated or associated with domain 602 based on this order. There are three charts (either in the result set or in answer to the structured query in the result set) that correspond to domain 602. First “Total transactions for Product Type: E Product Type by Sales country” 702 in FIG. 9 is a bar chart of total transactions on one axis with bars for—Country O. Country R, Country S, and Country T,—each showing the total transactions involving product type E in each of those countries. There is an equivalent bar chart 704 for Products Types F broken down by country with bars for the four country entries. Additionally there may be an overview chart 706 with all eight bars for each of the Product type and Sales Country combinations—“Total transactions for Product Type by Sales country”. Alternatively an overview chart would take the form of chart 706′ shown in FIG. 9b. Chart 706′ has just two bars one for product type E and the other for product type F. With such a simpler overview the computation and number of charts in the result set may be reduced with more complex charts such the series for all product of type E and F on the same chart achieved after searching by manually merging two charts. Consequently chart 706 could be produced by merging charts 702 and 704./

Domain 604 is also an ordered sequence of two attributes—first product name 42 and the sales regions 56 which has five charts associated with it in a similar manner to domain 602 such as “Total transactions for Product Name: A Product Name by Sales Region” 708.

Domains 606 and 608 are each ordered sequences of three attributes and consequently have more charts associated with them. Domain 606 is product name 42, sales regions 56 and Sales Country 54 in that order and an example chart is “Total transactions for Product Name: A Product Name by Sales Region:U by Sales Country” 708. Domain 608 is product category 46, product type 44 and Sales Region 56 in that order and an example chart 710 is “Total transactions for Product Category: I Product type:E by Sales Region”

In this example the result set only contains results based on the four domains 602, 604, 606 and 608. In process 100 a user enters Query 610 at step S102. Query 610 is “Product by Sales Location”. The first group of character “Product” matches all of the attributes 42, 44 and 46 of product dimension 40 but none of the attributes of sales location dimension 50. The second group of non-filtered characters “Sales Location” matches can match all of the attributes 52, 54 and 56 of sales location dimension 50 but none of the attributes of product dimension 40. This would provide nine possible attribute matches but since the result set is only based on domains 602-608 not all of those nine combinations are results that can be returned and instead only four are. This demonstrates that the expert user has decided that the other five combinations are not useful to view.

The four matches of attributes are Product Category 46—Product Type 44—Sales Region 56 (from domain 608), Product Name 42—Sales Region 56—Sales Country 54 (from domain 606), Product Name 42—Sales Region 56 (domain 604) and Product Type 44—Sales Country 54 (domain 602). These are then ranked in a manner that depends on how the query 610 matches the domains 602-608. The ranking can be done in two steps and the results of those steps are shown in tables 612 and 614.

As described above the first attribute in a domain is considered most important and the first group of characters in a query is also considered most important. In this case all four results have a first attribute which matches the first character group of query 610 ‘Product”. The next most important is the second group of character and second attribute. The result based on domain 608 does not match at this level since the second attribute if “Product Type” and does not match the second group of characters ‘Sales Location” whilst the results based on the other domains do. Consequently result 608 is scored fourth. Depending on the rules the other three could be scored equally based on the domain matching or as shown in table 612 result 606 Is lower ranked than 602 and 604 because it has an additional third attribute whist the other two results 604 and 602 have the same number of attributes as there are character group in query 610.

A second stage then uses the hierarchical dimensions 40 and 50 but in this particular the scores allocated by hierarchical decomposition are sufficiently smaller than the scores allocated by the first stage that the combined scores only alter the ranking relative t ranking using the first scores alone in respect of between results which were equal ranked by the first stage. In this case in table 612 results 604 and 602 are equal ranked by the first score. Turning to the first and most important attribute result 604 has product type 44 and result 602 has product name 42. Product type is higher up the hierarchy and therefore result 602 is given a higher second score so that it is ranked higher than result 604 as shown in table 614.

Once the ranking on table 614 is settled then the results can be displayed on display 9 via computer 11 to the user. As explained above this may take the form of structured queries or charts similar to those in FIG. 9. The full set of bar charts corresponding to domain 602 will be presented first (either alphabetically or if the content items are ranked in the ranked order) then all of the bar charts for domain 604 etc. The results may be displayed in a list as with many conventional web search engines or in another suitable format which has some order. For example they may be displayed in a carousel with the user rotating the carousel to move further down the ranking.

It can be noted that whilst the first stage of ranking step S110 was heavily dependent on the order and content of the query 610 the second stage is only dependent on the dimensions 40 and 50 and not the query 610. Consequently what was presented as the second stage above can be done in advance. Therefore all the result set can be pre-ordered in accordance with the hierarchical dimensions and stored in data storage 18 in that order. When this is done then step S110 merely needs to follow the first stage and maintain the initial stored order for results that are given the same ranking by the first stage.

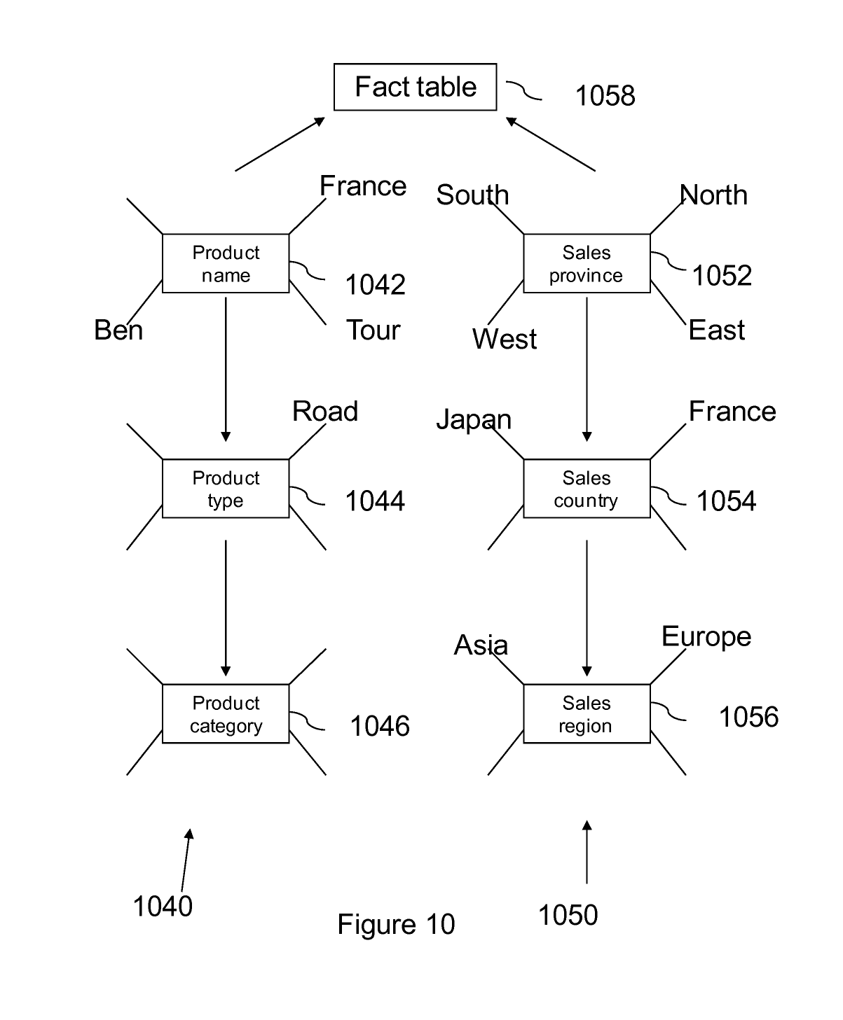

In FIG. 10 are two hierarchical dimensions 1040 and 1050. These dimensions are substantially the same as the dimensions 40 and 50 and like features are given the same reference number but increased by 1000. However in this example more specific content examples are given to illustrate the ranking process 100 when the user input at step S102 may contain a group of characters that matches with an item of content rather than an attribute.

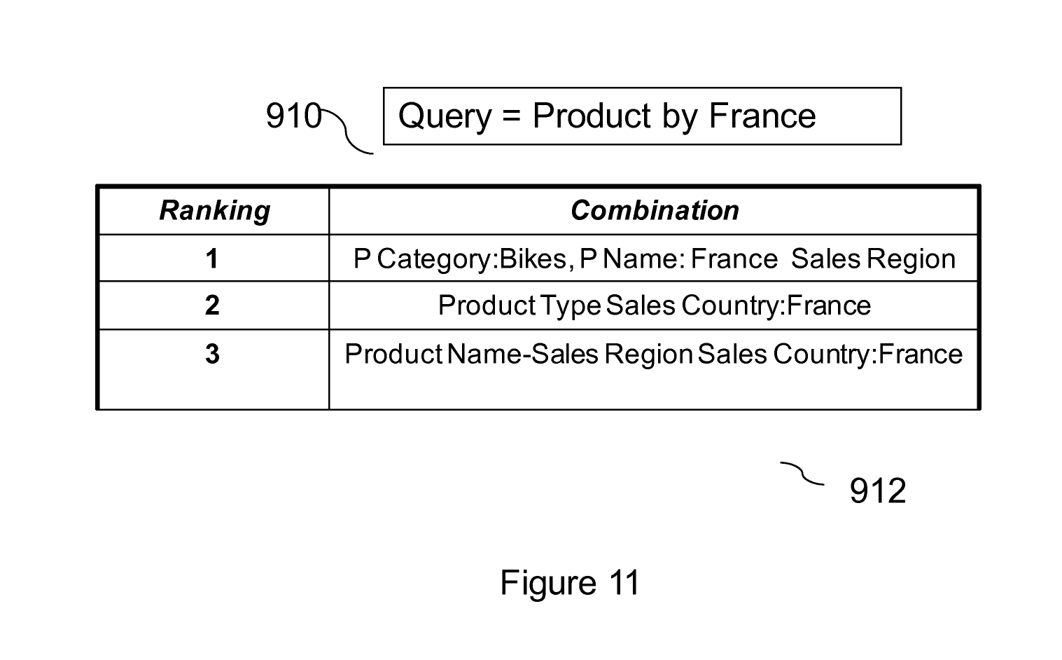

In FIG. 11 is query 910 “Product by France” which is input at step S102. Using the domains 602-608 the first group of characters “Product” matches attributes 42, 44 and 46 as with the previous example but the second group “France” does not match any names of attributes only content. “France” is the name of a country and matches with a content item of Sales Country 1054. However in this instance it is also the brand name of a Road Bike and matches with a content item of Product Name 1042. Here domains 602-608 are used but also 609—Product Category 46—Product Name 42—Sales Region 56

There are 3 out of 4 matches to the result set generated by the domains. These are 602—Product Type—Sales Country:France, 606—Product Name: Sales Region Sales Country:France and 610 Product Category:Bikes—Product Name:France Sales Region. There are no matches for 608 since there are no attributes listed which have ‘France” as an entry. There are no matches for 604 because the only entry for France is in place of the attribute Product Name 42 and therefore there are no results that separately have both “France” as an item and a match for “Product” as an attribute.

The ranking following step S110 is shown in table 912. The result from domain 606 Is ranked last because France is in the second group in the query 910 but in the third location in the result from domain 606 whereas for the other two results its location matches between query 910 and result. The result from domain 610 is ranked first because the first attribute Product category is higher in domain 1040 than Product Type.

When an expert user is generating domains system 100 may be configured so that the expert user only needs to write out long domains with multiple measures and attributes and that results based on only the starting attributes are generated automatically. In such a configuration domain 604 would usually be superfluous to domain 606 and all relevant results would be generated as a subset of domain 606.

Different attributes and content may be given different security access so that different users have access to them for the purposes of analysis. When this is done the domains which contain attributes that are blocked from that user are not used in step S100 and their corresponding results in the result set are blocked from being ranked and displayed to that user. This is used to limit access to data. For example, a human resource department may not have access to certain parts of an accounts department. The programming of the hierarchical dimension ensures that confidential data is not searchable by a different department. Because of this domain 604 may not be superfluous to domain 606 even if system 100 is configured to automatically generate subsets. This is because attribute “Sales Country” might be blocked from a given user but the attributes of domain 604 not blocked and therefore domain 604 can be used at step S1110 but domain 606 cannot.

Where an individual content item is blocked but not the attribute to which it belongs then relevant domains will be used at step S110 but results containing the blocked content item will be removed from display and preferably from the calculations also.

An example of users being given different security access is depicted in FIG. 12. Here, the same four domains 602-608 are provided as in FIG. 7, and the same query 610 is entered by users. However, in this instance, two different users, user 1 and user 2 have access to different domains. User 1 has access to domains 602, 604 and 608, but not domain 606, whilst user 2 has access to domains to 602, 606 and 608, but does not have access to domain 604. Because of their different access, the resulting ranking after the first stage on table 616 and 618 is different from the ranking in table 612. Table 616 for user 1 does not contain any results corresponding to domain 606 and table 614 for user 2 does not contain any results corresponding to domain 604.

1. A computer system for assisting searching of a database of a plurality of attributes, measures and content in order to answer analytical queries, the system comprising:
an input device for receiving word queries requesting information and/or metrics from the database;
a processor configured to process word queries requesting information and/or metrics from the database; and
a storage memory
containing a plurality of responses to word queries which responses contain and/or correspond to attributes, content and/or measures of the database,
and containing one or more ordered combinations of attributes wherein the attributes of the ordered combinations are in a set order,
the processor configured to match one or more words in a received word query with one or more attribute, content and/or measure in or corresponding to the stored responses,
to provide relevant responses to the input word query based on the matching,
and to rank the relevant responses, wherein the ranking of each relevant response is based at least partially on the position of one or more matched attributes of that relevant response within at least one ordered combination.

2. The computer system of claim 1 wherein the ordered combinations include a hierarchical dimension of related attributes where one of the attributes in the dimensions is a child/sub category of another of the attributes and the order of the combination reflects the hierarchy of the related attributes.

3. The computer system of claim 2 wherein the ranking of each relevant response is based at least partially on the position of one or more of the matched attributes of that relevant response in the hierarchy of a hierarchical dimension with parent attributes ranking above/scoring higher than child attributes.

4. The computer system of claim 1 wherein the ordered combinations include domains of attributes where the order reflects the order of attributes in one or more response and/or expected in word queries.

5. The computer system of claim 4 wherein the ranking of each relevant response is based at least partially on comparison of the position of one or more of the matched attributes of that relevant response to the position of the matched words within the word query so that responses with attributes/content/measures in the same position in the relevant response and the word query are ranked/scored more highly than those with them in different positions.

6. The computer system of claim 5 wherein the ranking is partially based on the position of the attributes/content/measures that are in the same position as words in the query so that a relevant response with an attribute and matched word both in the first position is ranked/scored more highly than a relevant response with an attribute and matched word both in the second position.

7. The computer system of claim 4 where some and preferably all of the query responses are derived from the domains.

8. The computer system of claim 1 comprising a display and wherein the processor is configured to present the ranked relevant results to a user on a display in response to the user entering a word query.

9. The computer system of claim 1 wherein the responses are structured analytical queries in the correct language to be applied to the database to return an answer relevant to the words in the word query.

10. The computer system of claim 9 wherein the system is configured so that in response to selection of relevant response the structured query is applied and the answer returned.

11. The computer system of claim 1 wherein the responses are answers to analytical queries.

12. The computer system of claim 11 wherein the answers are in the form of a chart with the attributes, content and/or measures of the database contained in/corresponding to the response present as a title of the chart or being stored as metadata.

13. The computer system of claim 1 wherein the ranking of each relevant response is based at least partially on the number of words in the received word query which are matched with at least an attribute, content and/or measure in or corresponding to the stored responses.

14. The computer system of claim 13 wherein the responses are given a first score for the number of matching words and at least some of the responses are given a second score for the position of matched attributes within at least one ordered combination and the ranking is at least partially based on a combination of the first and second score.

15. The computer system of claim 14 wherein responses with the same combined score are inversely ranked based on the number of unmatched words.

16. The computer system of claim 1 wherein the matched attributes are attributes contained in the response and match words in the query.

17. The computer system of claim 1 wherein the matched attributes are attributes to which content contained in the response, that match word in the query, belong to in the database.

18. The computer system of claim 1 wherein data values which belong to a plurality of attributes from or in the database is stored in the form of a plurality of linear sequences of two or more collections of data, each collection of data with a marked beginning and end, the linear sequences stored in the storage memory, each linear sequence corresponding to a particular value of a first attribute of the plurality of attributes, and including an identifying value which indicates the particular value of the first attribute,
each collection of data comprising a continuous entry of separated data values including a data value belonging to an attribute other than the first attribute, and a single other attribute identifier, which other attribute identifier corresponds to the attribute other than the first attribute,
and wherein two or more of the collections of data within the same linear sequence have other attribute identifiers which indicate, and include data values belonging to, attributes that are different from each other as well as different from the first attribute,
each linear sequence includes an identifying value which is different to the identifying value of the other linear sequences, so that on reading the data structure the attribute to which a read value belongs can be identified by determining the single other attribute identifier in the same collection of data,
and the particular value of the first attribute with which the read value is related can be identified by determining the identifying value of the linear sequence to which that same collection of data belongs.

19. A non-transitory storage medium containing instructions which when executed by one or more processors provides the computer system of claim 1.

20. A computer system for assisting searching of a database of a plurality of attributes, a plurality of fact measures and a plurality of facts, the system comprising:
a processor; and
a storage memory containing at least one, hierarchical order comprising an ordered list of at least some of the attributes stored in the database, wherein the computer system configured, so that in response to receiving a plurality of keywords from a user, it ranks and list of combinations of attributes, and/or fact measures and/or fact content in accordance with the ordered list of attributes in the hierarchical order.

21. A method of searching a database of a plurality of attributes, a plurality of fact measures and a plurality of facts, comprising:
entering a search query comprising a string of groups of characters;
matching at least one of the groups of characters in the search query to at least one of the plurality of attributes stored in the database;
preferentially ranking a summary of content combinations containing at least one attribute in accordance with at least one hierarchical order of attributes stored in the storage memory, the hierarchical order comprising an ordered list of decreasingly preferred attributes; and
displaying the ranked plurality of information.

22. The method according to claim 21, wherein the matched plurality of information is first ranked by order of a highest relevance before being ranked in accordance with the list of decreasingly preferred attributes of the hierarchical orders stored in the storage memory.
